(19) United States
(12) Patent Application Publication
(10) Pub. No.: US 2005/0117734 A1
(43) Pub. Date: Jun. 2, 2005

(54) System and method for telephone number portability

(76) Inventor: Richard Lee Higgins, Colorado Springs, CO (US)

Correspondence Address: LAW OFFICE OF DALE B. HALLING, 24 s. WEBER ST., SUITE 311, COLORADO SPRINGS, CO, 80903, US

(21) Appl. No.: 10/978,037

(22) Filed: Oct. 29, 2004

Related U.S. Application Data
(60) Provisional application No. 60/517,812, filed on Nov. 6, 2003.

(51) Int. Cl. H04M 7/00

(52) U.S. Cl. 379/221.13

(57) ABSTRACT

A system for telephone number portability has a first switch coupled between a first external telephone line and a users telephone. A second switch is coupled between a second external telephone line and the users telephone. A controller selectively opens and closes the first switch based on an incoming telephone call.

### RELATED APPLICATIONS

The present invention claims priority on provisional patent application Ser. No. 60/517,812, filed on Nov. 6, 2003, entitled “Device and Methodology for Simplifying the Local Number Portability Process by Allowing Multiple Carriers Simultaneous Access to customer Wiring”.

### FIELD OF THE INVENTION

The present invention relates generally to the field of telephony and more particularly to a system and method for telephone number portability.

### BACKGROUND OF THE INVENTION

Telephone numbers are an integral part of a consumers' identity in the community and the ability to allow a customer to retain their phone number provides the basis for true local telephone competition. Providers of alternative telephone services need to be able to port (or reuse) the customer's existing telephone number to be competitive. Alternate provides as used herein are defined as those providers not dependent on the Local Exchange Carriers (LEC) to access a customer's premise. Alternative providers may access the customer's premise by non-LEC twisted pair wire, coaxial cable, optical fiber, or wireless. The responsibility for porting an existing telephone number resides with the current provider which is usually the incumbent local exchange carrier.

Because the incumbent local exchange carrier (ILEC) is a direct competitor of the alternative provider, the local number porting (LPN) process is frequently contentious, cumbersome, and time consuming. The process requires a coordinated process between the incumbent local exchange carrier and the alternative provider with associated cost for both. The incumbent local exchange carrier must “port out” the telephone number (remove the telephone number from its customer service base) at the same time as the alternative provider “ports in” the telephone number (adds the telephone number to its customer base) in order for the customer to have continuous service.

Typically the incumbent local exchange carrier and the alternative provider agree on a date and time for the “porting” of the telephone number to take place. At the appointed time the alternative provider service technician and the incumbent local exchange carrier service technician perform what is referred to as a “hot cut”. The incumbent local exchange carrier service technician causes the appropriate databases within the public switched telephone network (PSTN) to be updated with the new information identifying the alternative provider as the service provider or “owner” of the telephone number. The alternative provider's service technician simultaneously updates the appropriate databases within the alternative provider's systems to “provision” the subscriber so that the alternative provider is now the service provider. Inbound and outbound calls will now pass through the alternative provider's equipment.

Because of the amount of required coordination and labor involved there is a high probability that errors will occur during the telephone number “porting”. This results in additional costs and frustration on the part of the customer.

Thus there exists a need for a system and method of telephone number porting that increases the probability of success of telephone number porting.

### SUMMARY OF INVENTION

A system for telephone number portability that overcomes these and other problems has a first switch coupled between a first external telephone line and a users telephone. A second switch is coupled between a second external telephone line and the users telephone. A controller selectively opens and closes the first switch based on an incoming telephone call. The first external telephone line may be a local exchange carrier telephone line. The controller may close the first switch and open the second switch when there is the incoming telephone call. The second external telephone line may not be a local exchange carrier telephone line. The controller may open the first switch and close the second switch when there is not the incoming telephone call. The controller may open the first switch and close the second switch when there is an out going telephone call. The first external telephone line may be a number of telephone lines.

In one embodiment a system for telephone number portability has a switch network that couples at least two external telephone lines to a users telephone. A controller changes a state of the switch network based on an incoming telephone call. One of the at least two external telephone lines is an incumbent local exchange telephone line. One of the at least two external telephone lines is an alternative provider telephone line. The switching network opens a switch to the incumbent local exchange telephone line when there is not the incoming telephone call. The switching network opens a switch to the alternative provider telephone line when there is the incoming telephone call. The switching network closes a switch to the incumbent local exchange telephone line when there is the incoming telephone call. The switching network closes a switch to the alternative provider telephone line when there is not the incoming telephone call. The user's telephone may be any appliance attached to a telephone line. The appliance may be a facsimile machine. One of external telephone lines may be carried over a coaxial cable. One of the external telephone lines may be an electromagnetic signal carried over the airwaves.

In one embodiment a method for telephone number portability includes the steps of determining if there is an incoming telephone call. When there is the incoming telephone call, a switch is closed between a users telephone and an external incumbent local exchange telephone line. When there is the incoming telephone call, a switch opened between an external alternative providers telephone line and the users telephone.

### BRIEF DESCRIPTION OF THE DRAWINGS

FIG. 1 is a schematic diagram of a system for telephone number portability in accordance with one embodiment of the invention;

FIG. 2 is a block diagram of a system for telephone number portability in accordance with one embodiment of the invention; and

FIG. 3 is a block diagram of a system for telephone number portability in accordance with one embodiment of the invention.

### DETAILED DESCRIPTION OF THE DRAWINGS

The present invention is a system and method for telephone number portability. The system has a controller(s) and switches that selectively connect a user's telephone to either an incumbent local exchange carrier or the alternative provider based on an incoming telephone call.

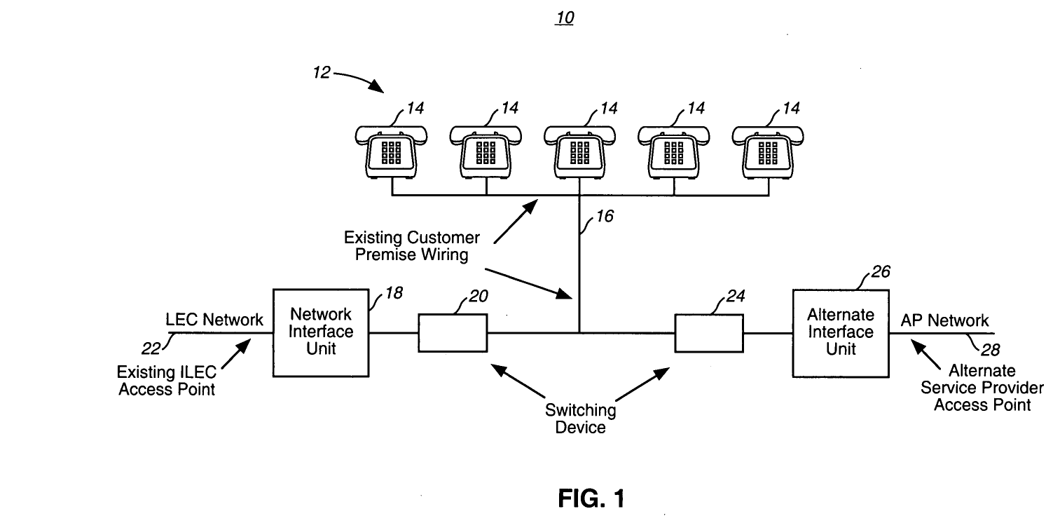

FIG. 1 is a schematic diagram of a system 10 for telephone number portability in accordance with one embodiment of the invention. A customer premise 12 has a number of telephones 14 coupled to inside wiring 16. The customer premise may be either a residence or a business. The inside wiring 16 is coupled to an existing incumbent local exchange carrier's network interface unit 18. The inside wiring 16 is coupled to the switching device 20. The switching device 20 is coupled to a network interface unit (NIU) 18. This is the incumbent local exchange carriers access point. The network interface unit 18 is coupled to the incumbent local exchange carriers external telephone line 22.

The inside wiring 16 is also coupled to a second switching device 24. The second switching device 24 is coupled to an alternative providers interface unit 26. This is the alternative provider's access point. The alternative interface unit 26 is coupled to an alternative provider's external telephone line 28.

In operation the switching devices are installed when a customer requests service from an alternative provider and wants to keep his telephone number. The first switching device 20 is designed so that a switch between the incumbent local exchange carrier's external telephone line 22 and the user's telephones 14 is open unless an incoming call over telephone line 22 is detected. The second switching device 24 is designed so that a switch in the device 24 is closed except when there is an incoming call on telephone line 22. There are four possible situations for the switching devices. In the default state the alternative provider telephone line 28 is connected to the user's telephones 14 and the incumbent local exchange carrier's external telephone line 22 is disconnected from the user's telephones 14. A second situation is when there is an off hook, an outbound call and then an on hook. When the telephone 14 goes off hook, the inside wiring 16 changes from twenty eight volts direct current (±28 VDC) to seven volts direct current (±7 VDC). The dialed digits (dual tone multi-frequency DTMF) are passed to the alternative provider telephone 28. When the call has ended, the telephone call goes back on-hook and the inside wiring 16 returns to twenty eight volts direct current (±28 VDC). The switching devices 20, 24 stay in there default state during this situation. Another situation is an inbound call over the ILEC telephone line 22 and no off hook event, in other words no answer to a ring. The switching device 20 detects a ring voltage (90 VAC @ 20 Hz). The switching device 20 connects the ILEC telephone line 22 to the inside wiring 16. The second switching device 24 detects the ring voltage and disconnects the alternative provider telephone line 28. When a ring voltage is not detected by the switching devices 20, 24 after one ring interval in one embodiment, the switching devices 20, 24 revert to their default state where the ILEC line 22 is disconnected and the alternate provider telephone line 28 is connected. Another situation is an inbound call over the ILEC telephone line 22 and off hook event (the call is answered) and an on hook event (user hangs up). The switching device 20 detects a ring voltage (90 VAC @ 20 Hz). The switching device 20 connects the ILEC telephone line 22 to the inside wiring 16. The second switching device 24 detects the ring voltage and disconnects the alternative provider telephone line 28. The telephone 14 goes off hook and the inside wiring 16 drops to seven volts direct current (±7 VDC). When the telephone 24 goes back on hook (user hangs up) the inside wiring transitions to twenty eight volts direct current (±28 VDC). The first switching device 20 detects this transition and disconnects the ILEC telephone line 22. The second switching device 24 detects this transition and connects the alternative provider line 28. The examples above are illustrative but not limiting. For instance, the voltages cited could be different.

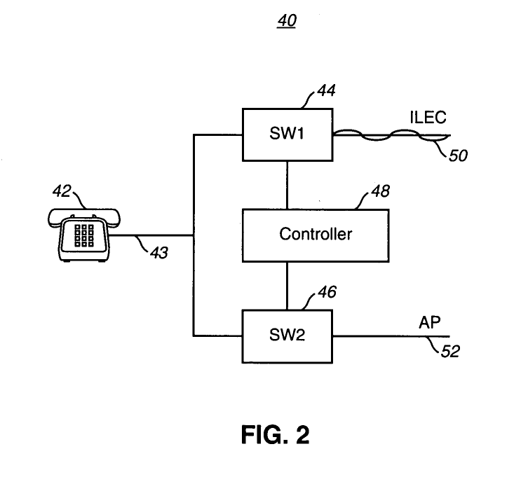

FIG. 2 is a block diagram of a system 40 for telephone number portability in accordance with one embodiment of the invention. A telephone 42 is connected by internal wiring 42 to a first switch 44 and to a second switch 46. The first switch 44 and the second switch 46 are connected to a controller 48. Note that each switch may have its own controller or a single controller may control both switches. In addition, the controller may be a microcontroller that runs embedded software or it may be constructed of electronic logic elements. The first switch 44 is connected to an ILEC telephone line 50 and the second switch 46 is coupled to an alternative provider telephone line 52. The device(s) incorporating the switches 44, 46 and controller 48 are installed when a customer requests that their local carrier be changed and that they keep their telephone number. From the time that the local number porting (LNP) process is requested until it is completed, the first switch 44 is in a normally open state. This example assumes that the customer is changing from the ILEC to the alternative provider, but the system will work equally well if the situation is reversed. The second switch 46 is normally closed. When a ring signal is present on the ILEC telephone line 50, the controller 48 detects this and closes the first switch 44 and opens the second switch 46. This allows the telephone 42 to receive calls from the ILEC until the telephone number is ported to the AP. When a ring signal is not detected for a predetermined period of time and no off hook signal is detected, the controller 48 opens the first switch 44 and closes the second switch 46. When an off hook signal is detected (after a rings signal from the ILEC line 50) and then a subsequent on hook signal is detected, the controller 48 opens the first switch 44 and closes the second switch 46. Note that once the telephone number is ported to the alternative provider the system always remains in the default state and is transparent to the user. Alternatively the system may be designed so that both switches are normally open until an inbound call is sensed on either line and then the switch associated with that line is closed. In this case, an off hook switch without a ring signal (out bound call) results in the controller 48 closing the second switch 46 and leaving the first switch 44 open. Note that having the ILEC telephone line 50 normally disconnected significantly reduces the load that would be imposed by the telephone line 50 otherwise.

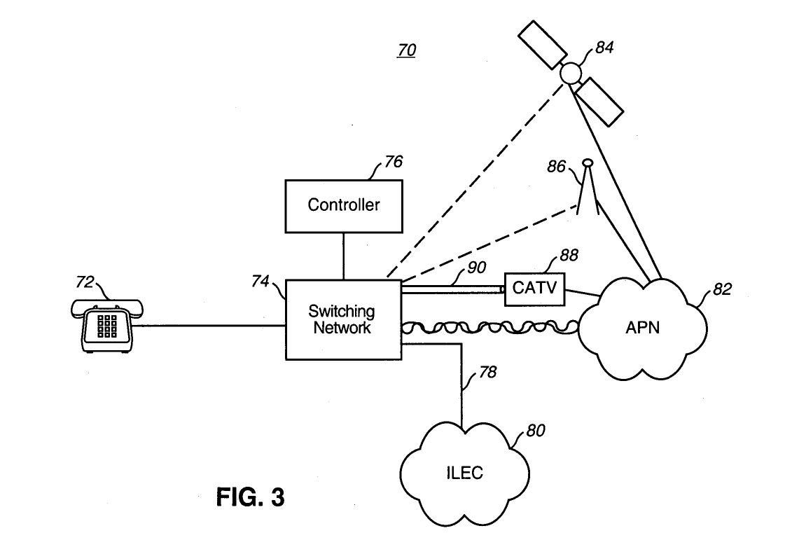

FIG. 3 is a block diagram of a system 70 for telephone number portability in accordance with one embodiment of the invention. A user's telephone 72 is coupled to a switching network 74. The state of the switching network 74 is controlled by a controller 76. The switching network 74 is coupled to a number of external phone lines. One of the external telephone lines 78 is a twisted pair telephone line owned by an incumbent local exchange (ILEC) carrier and connected to the ILEC network 80. An alternative provider network 82 may be connected by a satellite 84 or tower 86 wirelessly to the switching network 74 or by a cable television 88 cable 90 or a fiber optic cable. The switching network 74 allows a number of telephone lines to be ported at one location from a first service provider to a second provider. If a user wants to switch one or more telephone numbers from the ILEC 80 to an AP 82, the switching network would normally connect the phone(s) 72 to the AP line 90 and disconnect the ILEC line 78. When an inbound call from the ILEC line 78 is detected by the controller 76, the switching network 74 couples the telephone line 72 to the ILEC line 78 and disconnects the AP line 90. When the telephone call is ended or not picked up, the switching network 74 disconnects the telephone 72 from the ILEC line 78 and couples the telephone 72 to the AP line.

Thus there has been described a system and method of facilitating local number porting that does not require coordination between the ILEC and AP service technician. This is because a “hot cut” is no longer necessary to provide the customer with continuous service. The system is inexpensive enough that it may be left in place even after the local number has been ported.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A system for telephone number portability comprising:
a first switch coupled between a first external telephone line and a users telephone;
a second switch coupled between a second external telephone line and the users telephone; and
a controller selectively opening and closing the first switch based on an incoming telephone call.

2. The system of claim 1, wherein the first external telephone line is a local exchange carrier telephone line.

3. The system of claim 2, wherein the controller closes the first switch and opens the second switch when there is the incoming telephone call.

4. The system of claim 3, wherein the second external telephone line is not a local exchange carrier telephone line.

5. The system of claim 2, wherein the controller opens the first switch and closes the second switch when there is not the incoming telephone call.

6. The system of claim 2, wherein the controller opens the first switch and closes the second switch when there is an out going telephone call.

7. The system of claim 1, wherein the first external telephone line is a plurality of telephone lines.

8. A system for telephone number portability comprising:
a switch network coupling at least two external telephone lines to a users telephone; and
a controller changing a state of the switch network based on an incoming telephone call.

9. The system of claim 8, wherein one of the at least two external telephone lines is an incumbent local exchange telephone line.

10. The system of claim 9, wherein one of the at least two external telephone lines is an alternative provider telephone line.

11. The system of claim 10, wherein the switching network opens a switch to the incumbent local exchange telephone line when there is not the incoming telephone call.

12. The system of claim 11, wherein the switching network opens a switch to the alternative provider telephone line when there is the incoming telephone call.

13. The system of claim 10, wherein the switching network closes a switch to the incumbent local exchange telephone line when there is the incoming telephone call.

14. The system of claim 10, wherein the switching network closes a switch to the alternative provider telephone line when there is not the incoming telephone call.

15. The system of claim 8, wherein the users telephone may be any appliance attached to a telephone line.

16. The system of claim 15, wherein the appliance is a facsimile machine.

17. The system of claim 15, wherein one of the at least two external telephone lines is carried over a coaxial cable.

18. The system of claim 15, where one of the at least two external telephone lines is an electromagnetic signal carried over an airwaves.

19. The system of claim 15, where one of the at least two external telephone lines is carried over fiber optic cable.

20. A method for telephone number portability comprising the steps of:
a) determining if there is an incoming telephone call; and
b) when there is the incoming telephone call, closing a switch between a users telephone and an external incumbent local exchange telephone line.

21. The method of claim 19, further including the steps of:
c) when there is the incoming telephone call, opening a switch between an external alternative providers telephone line and the users telephone.
